(19) United States
(12) Patent Application Publication
(10) Pub. No.: US 2026/0206785 A1
(43) Pub. Date: Jul. 23, 2026

(54) SUNFLOWER-BASED COOKING CREAM

(71) Applicant: Time-Travelling Milkman B.V., Wageningen (NL)

(72) Inventors: Konstantinos Nikiforidis, Wageningen (NL); Foivi Nikolaou, Wageningen (NL); Gustav Maximilian Waschatko, Etterbeek (BE); Saskia Maria Basilla Tersteeg, Wageningen (NL)

(21) Appl. No.: 19/133,819

(22) PCT Filed: Nov. 30, 2023
(86) PCT No.: PCT/EP2023/083704

§ 371 Date: May 29, 2025

(30) Foreign Application Priority Data
Nov. 30, 2022 (NL) 2033647

(51) Int. Cl. A23D 7/005; A23L 9/20

(52) U.S. Cl. CPC A23D 7/0053; A23L 9/24

(57) ABSTRACT

The present invention relates to a method for obtaining a sunflower-based cooking cream, the method comprising a) providing a slurry comprising water and comminuted sunflower seeds, b) subjecting the slurry to liquid-solid separation to obtain a liquid composition comprising sunflower oleosomes, and c) adjusting the protein content before and/or after step b) to obtain a sunflower-based cooking cream comprising 10-40 wt. % sunflower oleosomes and between 0.5-15 wt. % sunflower protein.

### TECHNICAL FIELD

The present invention relates to a method for obtaining a plant-based cooking cream, and to the plant-based cooking cream obtainable by the method.

### BACKGROUND OF THE INVENTION

Plant-based cooking creams have become popular substitutes for dairy creams in part because a large number of people are either unable or unwilling to consume dairy products. Plant-based cooking creams also offer certain advantages over dairy creams, such as better shelf life and consistent quality and price.

US2022/322690 discloses an oil-in-water emulsion comprising a fat phase, a water phase and plant based protein. US2022/322690 discloses fat, water and plant-proteins as three different sources, i.e. no proteins are included in the oil phase. US2022/322690 additionally describes that the fat phase ingredients are heated to 60-80 degrees Celsius until the mixture is “clear”. An oleosome composition would not become clear upon heating, but would keep its milky/white appearance. Accordingly, the fat phase in US2022/322690 does not comprise oleosomes. Plant oils are typically extracted from plant seeds using chemical solvents (e.g.,), or cold pressing/(i.e., squeezed directly from sunflower seeds by crushing them), which processes destroy oleosomes (see e.g. de Figueiredo et al, Journal of Food Engineering 240 (2019) 49-55).

As a limitation, prior art plant-based cooking creams commonly lack stability, in particular at high temperatures, which is an important characteristic in order to prevent phase separation. To overcome this problem, current plant-based cooking creams comprise stabilizers, for example hydrocolloids such as maltodextrin or locust bean gum. Also, high-shear processing is sometimes applied, such as by high-pressure homogenization, in order to improve stability of the end product, but at the cost of process efficiency. Moreover, plant ingredients are frequently associated with allergenic responses, e.g. commonly-known for soy (bean). To achieve the necessary fat content in plant-based cream, oils derived from plant seeds are often used. However, these oils typically require further processing by refinement to improve the flavor, odor, color and stability. The refining process is not only hazardous, but also removes nutrients (e.g. proteins) and variations in the compositions.

Hence, current plant-based cooking creams, and the processes for obtaining them, leave room for improvement, in particular in terms of process efficiency and stability of the end product. It is an objective of the present invention to deliver at least one of these or other improvements.

### SUMMARY OF THE INVENTION

The present inventors found that oil seed-based cooking creams—particularly when based on sunflower, rapeseed, hemp, soy and almond—have exceptionally higher stability and cooking properties as compared other plant-based cooking creams.

Good results in the context of the current invention are achieved with sunflower seed, rapeseed, hemp seed, soy, and almond, but in particular with sunflower seeds, especially in combination with a minimal amount of oleosomes and a maximum amount of protein (e.g. a relatively low amount is preferably used).

High stability and/or cooking properties are in particular seen if the oil seed-based cooking cream is prepared with 10-40 wt. % oil seed oleosomes, preferably 10-40 wt. % sunflower oleosomes, and between 0.5-15 wt. % oilseed protein, preferably 0.5-15 wt. % sunflower protein. It appears that a relative amount of 70-95 wt. % oilseed fat (oleosomes), preferably 70-95 wt. % sunflower fat (oleosomes) and 5-30 wt. % oil seed protein, preferably 5-30 wt. % sunflower protein achieves excellent stability and cooking properties.

It was unexpectedly found that with the use of oil seed oleosomes, in particular sunflower oleosomes, and oil seed protein, in particular sunflower protein (in appropriate relative amounts) high cream stability can be achieved entirely using ingredients that are approved novel food, having clean label and being hypoallergenic, whilst eliminating the need for (undesirable) hydrocolloids or emulsifiers that are typically used in cooking creams.

It was found that the oil seed-based cooking cream has a surprisingly higher stability and ability to blend with food liquids also in high heat applications, as compared to cooking creams based on other plant seeds. The high heat resistance of the current cooking cream make it surprisingly more suitable for baking applications (and the like) as compared to other oleosome-based compositions which have are known from personal care or pharmaceutical applications.

It was found that, under certain conditions the solid waste stream separated from the oil seed slurry can be reworked to achieve the appropriate fat and protein content/relative amount in the oil seed-based cooking cream. The rework of the solid waste stream, either directly or by preparing a high protein fraction first, is found to be a surprisingly efficient way of carrying out the method of the invention while achieving an excellent cooking cream composition with high stability.

In an aspect, the current invention relates to a method for obtaining an oil seed-based cooking cream, the method comprising:
a) providing a slurry comprising water and comminuted oil seeds;
b) subjecting the slurry to liquid-solid separation to obtain a liquid composition comprising oil seed oleosomes;
c) adjusting the protein content before and/or after step b) to obtain an oil seed-based cooking cream comprising 10-40 wt. % oil seed oleosomes and between 0.5-15 wt. % oil seed protein, wherein the oil seed is preferably sunflower seed and/or the cooking cream is preferably sunflower-based cooking cream.

In an aspect, the current invention relates to an oil seed-based cooking cream, preferably a sunflower-based cooking cream, obtainable by the method of the invention.

In an aspect, the current invention relates to an oil seed-based cooking cream comprising 10-40 wt. % oil seed oleosomes and 0.5-15 wt. % oil seed protein, with respect to the total weight of the oil seed-based cooking cream, wherein the oil seed is preferably sunflower seed and/or the cooking cream is preferably sunflower-based cooking cream.

In an aspect, the current invention relates to a use of the oil seed-based cooking cream of the invention, preferably the sunflower-based cooking cream as cooking cream, preferably in a high heat application. For example, the use is preferably for high heat applications such as grilling, baking, and the like.

In an aspect, the current invention relates a use of oil seed oleosomes, preferably sunflower oleosomes and/or oil seed protein, preferably sunflower protein, for increasing stability of a cooking cream.

### DETAILED DESCRIPTION OF THE INVENTION

The method of the invention pertains to a method for obtaining an oil seed-based cooking cream, the method comprising combining a (liquid) composition comprising oil seed oleosomes and a (dry) composition comprising oil seed protein in amounts chosen to obtain an oil seed-based cooking cream comprising preferably 10-40 wt. % (sunflower) oleosomes and between 0.5-15 wt. % (sunflower) protein, with respect to the weight of the oil seed-based cooking cream.

Good results in the context of the current invention are achieved with sunflower seed, rapeseed, hemp seed, soy, and almond, but in particular with sunflower seeds.

In a preferred method, the method of the disclosure comprises:
a) providing a slurry comprising water and comminuted oil seeds;
b) subjecting the slurry to liquid-solid separation to obtain a liquid composition comprising oil seed oleosomes;
c) adjusting the (sunflower) protein content, preferably before and/or after step b) to obtain an oil seed-based cooking cream comprising 10-40 wt. % oil seed oleosomes and between 0.5-15 wt. % oil seed protein, wherein the oil seed is preferably sunflower seed and/or the cooking cream is preferably sunflower-based cooking cream.

The term “oil seed” (or “oilseed”) as used herein means a seed that yield edible oil, preferably a seed grown primarily for the production of edible oils. The oil seed of the current disclosure is preferably one or more selected from the group consisting of sunflower seed, rapeseed, hemp seed, soy, and almond. It appears beneficial in the content of the current invention if the oil seed has a minimal oil content., preferably of at least 15 wt. %, more preferably at least 20 wt. %, even more preferably of at last 30 wt. %, most preferably of at least 40 wt. %. In a preferred embodiment, the oil seed of the disclosure has an oil content of 25-45 wt. %. The present inventors consider a use of relatively high fat content in combination with relatively low protein content to achieve optimal stability and cooking properties.

Preferably, the oil seed of the invention is sunflower seed. Preferably, the oil seed-based cooking cream of the invention is sunflower-based cooking cream.

The term “sunflower seed protein” can herein be used interchangeably with the term “sunflower protein”. The term “sunflower seed oleosome” can herein be used interchangeably with the term “sunflower oleosome”. The term “sunflower seed oil” can herein be used interchangeably with the term “sunflower oil”. The term “sunflower seed fat” can herein be used interchangeably with the term “sunflower fat”.

The term “cooking cream” as used herein means an oil-in-water emulsified liquid composition intended to mix in a liquid form into foodstuff and beverages (to improve their creaminess, mouthfeel, appearance, and/or taste), in particular liquid foodstuff such as soup, sauce, gravies, custard bases, stews, and the like. The term “cooking cream” encompasses light cream, single cream, coffee cream and table cream. The cooking cream is preferably a non-dairy cooking cream, more preferably a plant-based cooking cream.

The cooking cream of the current disclosure is preferably a plant-based cooking cream. The term “plant-based” (cooking cream) as used herein means a (cooking cream) composition originating from plants, i.e. comprising plant protein and/or fat at least in higher amounts as compared to respectively animal protein and/or animal fats. Preferably, the term “plant-based” (cooking cream) means that the (cooking cream) composition contains (essentially) no animal protein and fat (e.g. less than 1%, more preferably lower than 0.1% of total protein or fat animal protein or fat). Typically, and also in the context of the current invention, “plant-based cooking cream” means the same as “non-dairy cooking cream”.

The term “oleosome” as used herein means a natural oil body as found in oil-bearing seeds. In particular, an “oleosome” is a membrane encapsulated oil droplet, wherein the oil droplet preferably comprises triacylglycerol and/or wherein the membrane preferably comprises phospholipid and protein, preferably wherein the protein comprises oleosin, caleosin, and/or steroleosin. In addition or alternatively, an “oleosome” can be seen as an intracellular (naturally occurring) oil body. An “oleosome” (and/or the encapsulated oil droplet) typically has a diameter of between 0.2-10 micron. The oleosomes in the context of the current invention are preferably sunflower oleosomes (i.e. extracted from sunflower seeds naturally bearing sunflower oleosomes). The oleosome of the current disclosure may be from seeds or nuts, such as one or more of sunflower seed, rapeseed walnut, canola, safflower seed, soybean, cotton seed, flax seed, maize, cashew nuts, peanuts, macadamia, peanut, rice, sesame seeds, macadamia, Brazil nut, avocado seed, and mango seed. The “oleosome” in the context of the invention is preferably a natural oleosome, meaning that it is derived or isolated from a naturally-occurring material such as seed. The term “oleosome” as used herein preferably excludes “artificial oleosomes” or “synthetic oleosomes”, referring to oleosome-like particles that are fabricated (e.g. assembled) and not found in nature as such (e.g. as described by Acevedo-Fani et al. Front Chem. 2020; 8: 564021). The term “oleosome” as used herein preferably excludes any fat phase or oil phase having a protein content of below 5, 4, 3, 2, 1, 0.5, 0.1 wt. %.

Preferably, all the protein (or at least 75 wt. %, or 90 wt. %, or 95 wt. % or 99 wt. %) in the cooking cream of the invention is oil seed protein and/or derived from processing of oil seed. Preferably, all the fat (or at least 75 wt. %, or 90 wt. %, or 95 wt. % or 99 wt. %) in the cooking cream of the invention is oil seed fat and/or derived from processing of oil seed.

In an embodiment, the (seed) protein in the context of the current invention is preferably a seed storage protein. The term “seed storage protein” as used herein means a protein that is predominantly that are predominantly synthesized during maturation of a seed and which are a major nitrogen source for a developing plant. The (seed) protein in the context of the current invention may be a globulin including 2S, 7S, 11S (i.e. helianthinin) and 15, an albumin, preferably a sunflower albumin including 2S albumin storage proteins, 11S albumin storage proteins and methionine-rich 2S proteins. It appears beneficial for the stability and/or cooking properties of the cooking cream if the composition comprises certain seed storage proteins, e.g. as particularly found in sunflower seeds.

In an embodiment, the protein as disclosed herein comprises:
75-97.5 wt. %, preferably 80-95 wt. %, more preferably 85-95 wt. %, of one or more globulins, calculated on the total dry weight of protein in the composition, wherein the globulin is preferably a sunflower globulin; and/or
1-25 wt. %, preferably 2.5-20 wt. %, more preferably 5-15 wt. %, of one or more albumins, calculated on the total dry weight of protein in the composition, wherein the albumin is preferably a sunflower albumin.

It is advantageous that all or most of the fat in the cooking cream is contained in oleosomes, e.g. at least 5, 10, 25, 50, 75, 90, 95, 100 wt. % of the fat (and/or oil) in the cooking cream is contained in oleosomes. In an embodiment, all of the fat in the cooking cream is derived from and/or contained in oleosomes. In an embodiment, at least 75%, preferably at least 85%, more preferably at least 90%, even more preferably at least 95%, most preferably at least 97.5% of the fat (and/or oil) in the cooking cream is derived from and/or contained in oleosomes. In addition or alternatively, it is advantageous that all or most of the protein in the cooking cream is oil seed protein, preferably sunflower protein. In an embodiment, all of the protein in the cooking cream is oil seed protein, preferably sunflower protein. In an embodiment, at least 75%, preferably at least 85%, more preferably at least 90%, even more preferably at least 95%, most preferably at least 97.5% of the protein in the cooking cream is oil seed protein, preferably sunflower protein.

The comminuting or comminution in the context of the current invention is preferably by one or more of pressing, screw pressing, homogenising, extruding, mixing, compressing, milling, blending and/or grinding. Preferably, the seeds are dehulled before the comminuting or comminution step.

The liquid-solid separation in the context of the current invention may be any process that separates non-soluble and soluble components, and preferably is or involves one or more of filtration (e.g. crude filtration, passive filtration, reduced pressure filtration), centrifugation, and/or use of a decanter. The liquid-solid separation preferably obtains a liquid composition comprising an oil seed protein and oil seed sunflower fats, and a solid composition comprising oil seed protein and oil seed fats.

In an embodiment, the filtration is passive filtration, meaning that it is carried out at atmospheric pressure. In an embodiment, the filtration is pressurised filtration, which means that it is carried out with preferably pressures up to 25 bar, more preferably up to 10 bar, even more preferably up to 5 bar.

In an embodiment, the filtration is followed by a centrifugation step (at relative low speeds) such as with g-forces below 15,000 g (i.e. g-force), preferably below 8000 g, more preferably below 5000 g. In an embodiment, the centrifugation step performed after filtration removes fibres from the filtrate and/or enriches the filtrate in oleosomes and proteins. Typically, when centrifugation after filtration is performed with g-forces exceeding 8000 g, less good results were obtained, hence it is preferred in the content of the current invention to use a g-force below 8000 g, for example 2000-8000 g or 4000-6000 g.

The present inventors surprisingly found that the solid waste stream separated from the oil seed slurry can be reworked (under certain conditions) to achieve the appropriate fat and protein content/relative amount in the oil seed-based cooking cream. Reworking of the solid solid waste stream in an efficient way of carrying out the method of the invention. In addition or alternatively, reworking of the solid waste stream may achieve a further improved composition with higher stability.

In a preferred embodiment, adjusting the protein content in the method involves combining the slurry of step a) with a composition comprising oil seed protein, preferably sunflower protein, in an amount chosen to obtain a slurry comprising preferably between 10-40 wt. % (sunflower) oleosomes and preferably between 0.5-15 wt. % (sunflower) protein with respect to the weight of the slurry.

In an embodiment, a solid composition comprising oil seed protein (and preferably also oil seed fat) is obtained from the liquid-solid separation in step b). In an embodiment, the solid composition comprising oil seed protein comprises:
40-70 wt. %, preferably 50-60 wt. % water; and/or
1-30 wt. %, preferably 10-20 wt. % oil seed protein; and/or
1-40 wt. %, preferably 5-30 wt %, more preferably 7.5-27.5 wt. % even more preferably 8.0-25 wt %, most preferably 10-17.5 wt. % oil seed fat (contained in oleosomes); and/or
0.5-15%, preferably 1-10 wt. % (sunflower) fiber, wherein the wt. % is with respect to the total weight of the solid composition comprising protein.

The solid composition comprising sunflower protein is preferably obtained as the solid phase when using a decanter of liquid-solid separation. The solid phase of liquid-solid separation (with a decanter) can be used to separate a light phase and a heavy phase. The light and heavy phases may be further concentrated, e.g. by centrifugation. In an embodiment, the (concentrated) light phase comprises 0.2-20 wt. %, preferably 1-10 wt. % protein and/or 0.2-20 wt. %, preferably 1-10 wt. % fat (contained in oleosomes). In an embodiment, the (concentrated) heave phase comprises 5-30 wt. %, preferably 10-20 wt. % protein and/or 1-30 wt. %, preferably 5-20 wt. % fat (contained in oleosomes). The solid composition comprising sunflower protein encompasses the (concentrated) light and heavy phases.

The terms “heavy phase” and “light phase” are in the context of the current invention preferably used employed to describe the materials which are separated from a mixture based on their relative densities, e.g. based on after the application of centrifugal force. For example, in a decanter centrifuge having a conveyor, the light phase material will usually be a liquid and the heavy phase material will usually be a mixture of solids and liquid.

The term “light phase” preferably refers to the phase which contains relatively more oil bodies and relative less soluble seed protein and/or the top layer after applying density centrifugation, whereas the heavy phase typically contains relatively less oil bodies and relatively more soluble seed protein and/or is the bottom layer after applying density centrifugation.

The solid composition comprising oil seed protein can be used (in step c) to further increase the protein content of the slurry of step a) and/or of the liquid composition comprising oil seed oleosomes of step b).

In an embodiment, the solid composition comprising sunflower protein is combined with the liquid composition comprising oil seed oleosomes. The combining of the solid composition comprising oil seed protein and the liquid composition comprising oil seed oleosomes can be performed in a wt. % ratio of 4:1-1:50, preferably 2:1-1:25, more preferably 1:1-1:10, even more preferably 1:2-1:6, most preferably 1:3-1:5.

In an embodiment, the solid composition comprising oil seed protein is subjected to one or more steps to produce a (concentrated) oil seed protein composition. The (concentrated) oil seed protein composition is preferably a (dried) protein concentrate or (dried) protein concentrate isolate. The (concentrated) oil seed protein composition can be used (in step c)) to adjust the protein content of the slurry of step a) and/or of the liquid composition comprising oil seed oleosomes of step b).

The term “(sunflower) protein concentrate” as used herein means a product with 25-80 wt. % (sunflower) protein. The term “(sunflower) protein isolate” as used herein means a product with more than 80 wt. % (sunflower) protein, e.g. 81-99 wt. %, preferably 85-97.5 wt. %, more preferably 90-95 wt. % (sunflower) protein.

In an embodiment, the solid composition comprising oil seed protein is preferably used to produce a (concentrated) oil seed protein composition comprising:
between 25-99 wt. %, preferably between 40-95 wt. %, more preferably between 50-80 wt. %, even more preferably between 60-70 wt. % oil seed protein; and/or
between 0.5-10 wt. %, more preferably 1-5 wt. % oil seed fat (contained in oleosomes), with respect to the total weight of the (concentrated) oil seed protein composition.

A preferred method of preparing the (concentrated) oil seed protein composition, involves one or more of the following steps:
resuspending the solid composition comprising oil seed protein in water, preferably in a concentration of 0.1-10% (w/v), preferably 1-5% (w/v);
adjusting the pH to 7-11, preferably 8-10 (e.g. by addition of 1 N NaOH);
centrifugation, preferably centrifugation at 2000-100,000 g, preferably 10-50,000 g (e.g. for 10-30 min) and obtaining the soluble protein fraction (supernatant);
repeating the previous step one, two, or more times and obtaining further soluble protein fractions (supernatant);
combining the soluble protein fractions (supernatant) to obtain a protein extract;
subjecting the protein extract to filtration, preferably diafiltration such as using extensive washing (e.g. using a 10 kDa TFF cartridge, Millipore Corporation, Bedford) to obtain a retentate;
drying the retentate, preferably by freeze drying or spray drying.

In a preferred embodiment, the slurry of the current disclosure comprises between 0.2-50 wt. % comminuted oil seeds and between 50-99.8 wt. % water more preferably 1-30 wt. % comminuted oil seeds and between 70-99 wt. % water, most preferably between 5-20 wt. % comminuted oil seeds and between 80-95 wt. % water with respect to the total weight of the slurry.

In a preferred embodiment, the liquid composition comprising oil seed oleosomes of the current disclosure comprises:
between 25-90 wt. %, preferably 50-70 wt. % water;
between 5-60 wt. %, preferably 20-40 wt. % (oil seed, e.g. sunflower) fat; and/or
between 0.2-20 wt. %, preferably 1-7.5 wt. % (oil seed, e.g. sunflower) protein; and/or
between 0.2-10 wt. %, preferably 1-2 wt. % (oil seed, e.g. sunflower) carbohydrates; and/or
between 0.01-5 wt. %, preferably 0.1-1 wt. % (oil seed, e.g. sunflower) minerals, with respect to the total weight of the liquid composition.

In a preferred embodiment, the composition comprising oil seed protein comprises:
between 20-99 wt. %, preferably between 40-95 wt. %, more preferably between 50-70 wt. % (oil seed, e.g. sunflower) protein; and/or
between 0.1-20 wt. %, preferably between 0.5-10 wt. %, more preferably between 2-4 wt. % (oil seed, e.g. sunflower) fat; and/or
between 1-50 wt. %, preferably between 5-40 wt. %, more preferably between 10-30 wt. % (oil seed, e.g. sunflower) fiber; and/or
between 1-20 wt. %, preferably between 2-10 wt. %, more preferably between 4-8 wt. % (oil seed, e.g. sunflower) carbohydrates, with respect to the total weight of the composition comprising sunflower protein.

In a preferred embodiment, the composition comprising oil seed protein is obtained from the solid phase of the liquid-solid separation in step b). In a preferred embodiment, the composition comprising oil seed protein is a protein concentrate or protein isolate obtained from the solid phase of the liquid-solid separation in step b).

In a preferred embodiment, the slurry comprising water and comminuted oil seeds, preferably sunflower seeds is obtainable (or obtained) by
i) immersing oil seeds, preferably sunflower seeds, preferably dehulled sunflower seeds, in aqueous medium;
ii) comminuting the immersed oil seeds, preferably sunflower seeds, preferably by blending, mixing, milling and/or compressing.

The immersing in aqueous medium (e.g. water) may be for at least 4, 8, 12, 24 hours and/or in aqueous medium (e.g. water) having a temperature of between 0-10, preferably 1-6 degrees Celsius.

In a preferred embodiment, the liquid-solid separation is performed by filtration, centrifugation, and/or by using a cream separator (e.g. decanter, tricanter). An advantage of a cream separator in the context of the current invention is that it can separate 2 or 3, or more liquid phases using centrifugal forces in a continuous process. The method according to the present invention may be a continuous process.

In a preferred embodiment, the oil-based cooking cream (e.g. obtained in step c) is pasteurized and/or subjected to Ultra-High-Temperature (UHT) treatment.

In an embodiment, the method of the current disclosure involves high-pressure homogenization. In an embodiment, the method of the current disclosure does not involve high-pressure homogenization.

In an embodiment, the composition obtainable by the method of the current disclosure is dried to make a powder, e.g. which can be reconstituted to cream. The drying is selected from the group consisting of spray drying, freeze drying, vacuum drying, preferable spray drying. Spray drying is preferably performed at a temperature between 80 and 200 degrees Celsius. In an embodiment, the drying is performed on the liquid composition comprising sunflower oleosomes without prior washing and/or or further prior cleaning, but is used as it is obtained from the extraction process. In certain preferred embodiments, the drying step is performed directly on the oleosome composition/extract (without intermediate steps between).

The current invention pertains to an oil seed-based cooking cream, preferably a sunflower-based cooking cream which is preferably obtainable or obtained by the method as disclosed herein.

The oil seed-based cooking cream preferably comprises 10-40 wt. % (oil seed, e.g. sunflower seed) oleosomes and 0.5-15 wt. % (oil seed, e.g. sunflower seed) protein, with respect to the total weight of the oil seed-based cooking cream.

The oil seed-based cooking cream may comprise 5-75 wt. %, preferably 10-40 wt. %, more preferably 15-25 wt. % (oil seed, e.g. sunflower seed) oleosomes and/or fat. The oil seed-based cooking cream may comprise 0.1-25 wt. %, preferably 0.5-15 wt. %, more preferably 1-10 wt. % (oil seed, e.g. sunflower seed) protein. The oil seed-based cooking cream may comprise 40-90 wt. %, preferably 50-85 wt. %, most preferably 60-78.5 wt. % water. The oil seed-based cooking cream may comprise 0.5-25 wt. %, preferably 1-15 wt. %, more preferably 2-10 wt. %, most preferably 3-5 wt. % (oil seed, e.g. sunflower seed) fiber.

In a preferred embodiment, the oil seed-based cooking cream comprises
between 60-78.5 wt. % water;
between 15-35 wt. % fat; and
between 1-10 wt. % protein
   with respect to the total weight of the oil seed-based cooking cream.

In a preferred embodiment, the oil seed-based cooking cream comprises preferably 50-99 wt. % (oil seed, e.g. sunflower seed) fat and 1-50 wt. % (sunflower) protein, preferably 70-95 wt. % (sunflower) fat and 5-30 wt. % (oil seed, e.g. sunflower seed) protein, more preferably 80-90 wt. % (oil seed, e.g. sunflower seed) fat and 10-20 wt. % (oil seed, e.g. sunflower seed) protein calculated on the total weight of fat and protein.

The present inventors found that a minimal amount of fat is beneficial for achieving high stability and/or cooking properties. Preferably, the fat content in the oil seed-based cooking cream is at least 10 wt. % oleosome (fat), or at least 15 wt. % oleosome (fat), or at least 20 wt. % oleosome (fat) or at least 25 wt. % oleosome (fat) or at least 30 wt. % oleosome (fat), with respect to the total weight of the oil seed-based cooking cream.

The present inventors found that there is an optimal protein range beneficial for achieving high stability and/or cooking properties. Preferably, the protein content in the oil seed-based cooking cream is 0.1-30 wt. %, preferably 0.2-25 wt. %, more preferably 0.3-30 wt. %, even more preferably 0.5-15 wt. %, most preferably 1-10 wt. %, with respect to the total weight of the oil seed-based cooking cream.

In a preferred embodiment, adjusting the protein content involves combining the liquid composition comprising oil seed oleosomes of step b) with a composition comprising oil seed protein in an amount chosen to obtain an oil seed-based cooking cream comprising between preferably 10-40 wt. % (oil seed, e.g. sunflower seed) oleosomes and preferably between 0.5-15 wt. % (oil seed, e.g. sunflower seed) protein with respect to the weight of the oil seed-based cooking cream.

In a preferred embodiment, the oil seed-based cooking cream is liquid.

The cooking cream of the invention was found to have an improved stability, for example as compared to cooking cream prepared from other plant ingredients. There appears to be a optimal amount of oil seed fat, in particular sunflower fat (oleosome) and/or oil seed protein, in particular sunflower protein to achieve high(est) stability of the cooking cream. In addition or alternatively, there appears to be an optimal relative amount of oil seed fat, in particular sunflower fat (oleosome) and oil seed protein, in particular sunflower protein, to achieve high(est) stability of the cooking cream.

In an embodiment, the oil seed-based cooking cream, preferably the sunflower-based cooking cream has a higher stability compared to a cooking cream with the same composition or formulation, but based on one or more other plant seeds.

The current invention pertains to a use of oil seed (e.g. sunflower)-based oleosomes and/or oil seed (e.g. sunflower) protein for increasing stability of a cooking cream (i.e. relative to not using said oil seed (e.g. sunflower)-based oleosomes and/or oil seed (e.g. sunflower) protein).

The stability of the cooking cream is preferably defined/determined by the creaming rate, wherein an increase in stability is defined by a decrease in creaming rate (%). A high creaming rate means a high transmittance, which means that more creamed layer is formed after the centrifugation and indicates that the recombined cream has poor stability. The creaming rate can be measured using a dispersion analyzer such as a LUMiSizer (LUM LUMGmbH, Germany) and preferably following an executed standard like the ISO TR 13097. A preferred protocol is along the lines of what is described by Zhou et al. (International Journal of Food Properties, 20:10, 2223-2233), i.e. employing STEP technology, which allows the measurement of the intensity of transmitted near-infrared (NIR) light as function of time and position over the entire sample length without scanning. The measurement scheme is described by Sobisch and Lerche (Colloids & Surfaces A Physicochemical & Engineering Aspects 2008, 331(1-2), 114-118)/The following instrument parameters are used for the measurements: (1) 1500 rpm, (2) 3600 s time_{Exp}, (3) 10 s time interval, (4) 25° C. temperature, and (5) a light factor of 1.00.

In an embodiment, the creaming rate of the oil seed (e.g. sunflower)-based cooking cream is lower than the creaming rate of a same cooking creaming (i.e. having the same composition or formulation), but based on one or more other plant seeds. In an embodiment, the creaming rate of the oil seed (e.g. sunflower)-based cooking cream is less than 30% (e.g. less than 20%), preferably less than 15%, more preferably less than 10%, even more preferably less than 5%, most preferably less than 2% (e.g. less than 1% or 0.5%). The creaming rate of the oil seed (e.g. sunflower)-based cooking cream may be in the range of 0.5-20%, or 1-15%, or 2-10%, or 3-7.5%, or 4-5%. In a preferred embodiment, the oil seed (e.g. sunflower)-based cooking cream has a stability as determined by a phase separation rate of less than 2.5×10⁻⁵ mL/s, preferably less than 2×10⁻⁵ mL/s.

In addition or alternatively, the stability of the cooking cream is preferably defined/determined by the phase separation rate (mL/s). The phase separation rate can be determined by generating a volume (V) versus time (t) profile, for example based on the method by Grossmann et al. (Compr. Rev. Food Sci. Food Saf., vol. 20, no. 2, pp. 2206-2233, 2021).

In an embodiment, the phase separation rate of the oil seed (e.g. sunflower)-based cooking cream is lower than the phase separation rate of a same cooking creaming (i.e. having the same composition or formulation), but based on one or more other plant seeds. In an embodiment, the phase separation rate of the oil seed (e.g. sunflower)-based cooking cream is less than 2.0×10⁻⁶ mL/s, (e.g. less than 1.0×10⁻⁶ mL/s), preferably less than 5.0×10⁻⁵ mL/s, more preferably less than 2.5×10⁻⁵ mL/s, even more preferably less than 2.0×10⁻⁵ mL/s, most preferably less than 1.5×10⁻⁵ mL/s or 1.0×10⁻⁵ mL/s. The phase separation rate of the oil seed (e.g. sunflower)-based cooking cream may be in the range of 0.5×10⁻⁵-1.0×10⁻⁶ mL/s, or 1.0×10⁻⁵-5.0×10⁻⁵ mL/s, or 1.5×10⁻⁵-2.5×10⁻⁵ mL/s.

In a preferred embodiment, the oil seed (e.g. sunflower)-based cooking cream of the invention has a stability defined by a phase separation of less than 2.5×10⁻⁵ mL/s, preferably less than 2×10⁻⁵ mL/s.

In an embodiment, the oil seed (e.g. sunflower)-based cooking cream can be stored without phase separation, oxidation and/or microbial spoilage for at least 6 months, preferably at least a year, preferably at least 18 months, preferably at least 2 years. The cooking cream may be stored at 4-10° C. or at room temperature.

It was found that the oil seed-based cooking cream of the disclosure, in particular the sunflower-based cooking cream, has a surprisingly high stability and ability to blend with food liquids also after at high heat, e.g. also compared to cooking cream based on one or more other plant seeds. The present inventors consider that the oil seed (e.g. sunflower)-based cooking cream is particular suitable for use in high heat culinary applications, also when reheated, without curdling or breaking.

In an embodiment, the invention relates to a use of the oil seed (e.g. sunflower)-based cooking cream of the disclosure:
at a temperature above 100° C., preferably above 125° C., more preferably above 150° C., even more preferably above 200° C., most preferably above 250° C.; and/or
in one or more of baking, frying, roasting, grilling, steaming, poaching, simmering, broiling, blanching, braising, and/or stewing,
e.g. in combination with a cooking time of more than 15 min, or more than 30 min, or more than 60 min, or more than 120 min, or more than 240 min, wherein the cooking cream preferably does not curdle or break.

It was found that the oil seed (e.g. sunflower)-based cooking cream can be reheated, without curdling or breaking. In an embodiment, the invention relates to use of the oil seed (e.g. sunflower)-based cooking cream in reheat applications.

The oil seed (e.g. sunflower)-based cooking cream putatively has an improved viscosity, e.g. as compared to cooking cream based on one or more other plant seeds. In an embodiment, the oil seed (e.g. sunflower)-based cooking crema of the disclosure has an improved (absolute viscosity, centipoise, Cp) compared to a same (i.e. having same composition or formulation) cooking cream, but based on one or more other plant seeds, meaning that the viscosity is in the appropriate range (i.e. not too high or not too low). In embodiment, the oil seed (e.g. sunflower)-based cooking cream of the disclosure has an absolute viscosity (i.e. dynamic viscosity, expressed in cP) of 5-100 cP, preferably 10-75 cP, more preferably 15-50 cP, even more preferably 20-40 cP, preferably in combination with a fat and/or protein content as disclosed herein, and/or measured at 3-4° C., 20-22° C., or 31-33° C.

The oil seed (e.g. sunflower)-based cooking cream may have an absolute viscosity of at least 5, 10, 15, 20, 30, 40, 50, 60, 70, 80, 90, 100, 125, or 150 cP. In addition or alternatively, the oil seed (e.g. sunflower)-based cooking cream may have an absolute viscosity of no more than 150, 125, 100, 90, 80, 70, 60, 50, 40, 30, 30 or 10 cP.

The term “absolute viscosity” (i.e. also called “dynamic viscosity”) as used herein is a measure relating to a fluid's internal resistance to flow, and the amount of force needed to effect a fluid flow. Preferably, the dynamic viscosity as disclosed herein is measured using a commercially available automated viscometer (e.g. m-VROC, RheoSense, measured using 100 microliter sample volume, more preferably at a temperature of 20-22° C.).

The oil seed (e.g. sunflower)-based cooking cream of the disclosure preferably comprises no more than 5 wt. %, more preferably no more than 1 wt. %, yet more preferably no more than 0.1 wt. %, most preferably more than 0.01 wt. % hydrocolloids (i.e. a substance that forms a gel with water), or comprises no (i.e. is free of) hydrocolloids, preferably when it is (or used as) a thickener. The term ‘thickener’ relates to any ingredient that may be incorporated into a foodstuff to increase the viscosity. The skilled person is well-aware of ingredients that may serve as thickener in food products. Examples of hydrocolloids and/or thickeners to be considered in the context of the current invention are one or more of the group consisting of: locust bean gum, carrageenan, seaweed extract, guar gum, xanthan gum, extracellular polysaccharide gum, scleroglucan, agar, pectin, alginate, cellulose derivatives, gum tragacanth and/or gum arabic, and combinations thereof. A thickener as taught herein may or may not additionally serve as a stabiliser and/or emulsifier.

Preferably, the oil seed (e.g. sunflower)-based cooking cream does comprise one or more of carbohydrates, proteins, fats, vitamins, minerals, and fibre that are not derived from sunflower, and in addition or alternatively, the oil seed (e.g. sunflower)-based cooking cream in dry form (or when excluding water) preferably does not have ingredients that are not derived from oil seed (e.g. sunflower), e.g. preferably less than 20 wt. %, more preferably less than 10 wt. % even more preferably less than 5 wt. %, most preferably less than 1 wt. %.

In an embodiment, all of the fat in oil seed (e.g. sunflower)-based cooking cream is derived or contained in (sunflower) oleosomes or at least 75 wt. %, more preferably at least 90 wt. %, yet more preferably at least 95 wt. %, most preferably at least 99 wt. % of the fat in the oil seed (e.g. sunflower)-based cooking cream is derived or contained in (sunflower) oleosomes.

In a preferred embodiment, the oil seed (e.g. sunflower)-based cooking cream of the disclosure comprises:
no hydrocolloids, or not more than 1 wt. % hydrocolloids; and/or
only oil seed (e.g. sunflower)-based ingredients, or no more than 2 wt. % non-oil seed (e.g.) sunflower ingredients, all with respect to the total weight of the oil seed (e.g. sunflower)-based cooking cream in dry form (or excluding water), wherein the ingredient is one or more of carbohydrates, proteins, fats, vitamins, minerals, and fibre.

In an embodiment, the oil seed (e.g. sunflower)-based cooking cream is hypoallergenic. The (lack of) hypoallergenicity can for example be determined/defined by an in vitro model, such as the in vitro model developed by Stickler et al. (Environ Health Perspect. 2003 February;111(2):251-4) which is used to study the pro-allergenic activity of a test substance. In brief, dendritic cells are differentiated in vitro from human blood monocytes derived from healthy donors, including the addition of IL-1a and TNF-α on day 5 of culture. Purified CD4+ T cells (from the same donor) are cocultured with the dendritic cells in the presence of the extracts for 5 days. Proliferation is assessed by tritiated thymidine incorporation. The pro-allergenic response is expressed as the stimulation index (SI). The SI for each extract is calculated by dividing the average proliferation by the average proliferation of control wells containing dendritic cells, CD4+ T cells, and dimethyl sulfoxide in the absence of extract. In an embodiment, a hypoallergenicity is defined by a comparable SI index (e.g. statistically non-significant difference, less than 5% difference) for the sunflower-based cream an appropriate control (such as a blank or a control cooking cream that is known to be hypoallergenic). The hypoallergenicity can also be established by adhering to the ISO 22000, since the management of allergens is a required by this international standard. The ISO 22002 specifies requirements for establishing, implementing and maintaining an allergen management program, such as based on the scientific approach of risk analysis, the HACCP principles, and by assessing allergen hazards.

In an embodiment, the oil seed (e.g. sunflower)-based cooking cream is a clean label cooking cream. The term “clean label” as used herein means. Preferably, clean label means that there are no artificial ingredients (i.e. all ingredients are natural) and/or additives in general that are perceived as unhealthy.

Preferably, the oil seed (e.g. sunflower)-based cooking cream (or the clean label cooking is defined by) an absence of (i.e. is free of) one or more of the following, preferably absence of all of the following:
(artificial) food colouring, such as identified by an E number according to the International Numbering System, e.g. one or more of a food colour additive (E100-E199);
artificial flavour ingredients, e.g. identified by one or more of E600-E699;
(artificial) preservatives, e.g. such as antioxidants or acidity regulators (e.g. E300-E399);
(artificial) antimicrobial compounds, e.g. identified by E200-E299 and/or E700-E799;
(artificial) emulsifier, stabilizer, and/or thickening agent, e.g. as identified by one or more of E400-E499;
genetically modified organism (GMO).

The terms “absence of” “free of” as used herein mean that the amount of a substance or compound is not measurable according to a standard technique in the field and/or is below a certain threshold, preferably below 0.1 (v/v or w/v), more preferably below 0.01 (v/v or w/v), even more preferably below 0.001 (v/v or w/v), most preferably below 0.0001 (v/v or w/v).

In a preferred embodiment, the
oil seed (e.g. sunflower)-based cooking cream is hypoallergenic; and/or
the oleosomes and protein are hypoallergenic; and/or
the oil seed (e.g. sunflower)-based cooking cream is a clean label cooking cream.

In a preferred embodiment, the oil seed (e.g. sunflower)-based cooking cream comprises:
no hydrocolloids, or not more than 1 wt. % hydrocolloids; and/or
only oil seed (e.g. sunflower)-based ingredients, or no more than 2, 3, 4, 5, 6, 7, 8, 9, 10, 15, 20 wt. % non-oil seed ingredients (e.g. non sunflower ingredients), all with respect to the total weight of the oil seed (e.g. sunflower)-based cooking cream in dry form.

Preferably, the oil seed (e.g. sunflower)-based cooking cream does not comprise palm oil (or derivatives thereof), (multi fractionated) palm oil stearin, palm kernel stearin, palm kernel oil, or not more than 2, 3, 4, 5, 6, 7, 8, 9, 10, 15, 20 wt. % of any of those.

In this document and in its claims, the verb “to comprise” and its conjugations is used in its non-limiting sense to mean that items following the word are included, but items not specifically mentioned are not excluded.

In this document and in its claims, reference to an element by the indefinite article “a” or “an” does not exclude the possibility that more than one of the element is present, unless the context clearly requires that there be one and only one of the elements. The indefinite article “a” or “an” thus usually means “at least one”. Weight percentage may be with respect to total (dry) weight.

In the context of the current invention, the terms ‘to increase’ and ‘increased level’ and the terms ‘to decrease’ and ‘decreased level’ refer to the ability to significantly increase or significantly decrease or to a significantly increased level or significantly decreased level. Generally, a level is increased or decreased when it is at least 5%, such as 10%, 15%, 20%, 25%, 30%, 35%, 40%, 45%, 50% higher or lower, respectively, than the corresponding level in a control or reference. Alternatively, a level in a sample may be increased or decreased when it is statistically significantly increased or decreased compared to a level in a control or reference. The term “to reduce” may herein be used interchangeably with “to decrease”. The term “reducing” may herein be used interchangeably with “decreasing”.

The following Examples illustrate the different embodiments of the invention.

### EXAMPLES

### Preparing Liquid Composition Comprising Sunflower Oleosomes

### Lab Scale

100 g of bakery grade fully dehulled intact sunflower seeds (Linoleic variety) are soaked in tap water over night in the fridge and washed the next day under running water. Soaked seeds were combined with water to reach a total weight of 1000 g and blended 90s at 10200 rpm in a Thermomix TM6. The resulting slurry was filtered through 2 layers of cheese cloth. The solution was filled into six 50 mL centrifuge tubes (Roth), which were centrifuged in a Thermo Heraeus Multifuge X1R with 15000xg at 4° C. for at least 5 h. The resulting floating fractions (cream layer, fat pat, oleosomes) were lifted with a small spoon and resuspended in water to achieve a fat content of 60% and a protein content of 2%. The diluted “cream” was heat treated in a water bath to increase the shelf life and stored in the fridge until the day of the experiment.

### Pilot Scale

100 kg of bakery grade fully dehulled intact sunflower seeds (Linoleic variety) are soaked in tap water over night. The washed soaked seeds were milled in a line of colloid mills (FrymaKoruma ML 150+MZ 100) together with 900 kg of water and the resulting slurry was decanted using a GEA decanter (SCE 306-71-32). The light phase of the decanter was further concentrated in an Alfa-Laval (MRPX 214-44T) centrifuge. The light phase of the centrifuge was heat treated in a Combitherm UHT and filled in sterile bags. The final composition measure was 62,5% water, 32% fat, 2% protein.

### Preparing Sunflower-Based Cooking Cream

### Materials

Liquid composition comprising sunflower oleosomes (34% fat, 2% protein, 1.5% carbohydrates, 0.5% minerals) was provided by TTM (Time-Travelling Milkman, The Netherlands), and a composition comprising sunflower proteins (60% protein, 21% fiber, 5.6% carbohydrates, 3% fat) was provided by Sunbloom (Sunbloom Proteins GmbH, Germany).

### Methods

### Cooking Cream Preparation

Sunflower-based cooking cream recipes, 10-40 wt. % sunflower oleosomes and 2.5-10 wt. % sunflower protein, were developed for physical characterization. Sunflower seed oleosomes were the source of fat, whereas sunflower seed proteins were the source of protein. All ingredients were hydrated in potable/tap water at 85° C. in a heated blender (Vorwerk Thermomix TM6, Germany) for 8 minutes at speed 4. Upon completion of the heating step, the mixture was sheared for 3 minutes at speed 10. The cooking cream was then poured into a glass jar and stored at 4° C. for a maximum of 3 days. Samples' composition is presented in Table 1.

TABLE 1
Cooking cream sample composition.

| | Clean label | Clean label | Clean label |
|---|---|---|---|
| Ingredients (%) | 2% protein | 5% protein | 7.5% protein |
| Sunflower oleosomes | 25.0 | 25.0 | 25.0 |
| Tap Water | 73.0 | 70 | 67.5 |
| Sunflower protein | 2.0 | 5.0 | 7.5 |

### Gravitational Separation

Oil droplet separation by gravity can appear as creaming (oil lighter than water) during product storage. The gravitational separation was determined by placing 100 mL of the cooking cream sample in a volumetric cylinder and monitor the serum volume over time. A layer of serum at the bottom of the cylinder was visible during storage. The volume of these layers was quantified using a ruler. The creaming rate was estimated by generating a volume (V) versus time (t) profile (based on Grossmann et al 2021, Comprehensive Reviews in Food Science and Food Safety 20(4)).

### Results

Phase separation rate (mL/s)

| | |
|---|---|
| Clean label 2% protein | 2.52E−05 |
| Clean label 5% protein | 2.48E−05 |
| Clean label 7.5% protein | 1.69E−05 |

As can be seen, the phase separation rate was favourably and drastically reduced as more sunflower protein was comprised in the cooking cream.

Comparison of Creams Obtained from Different Plant Seeds, and Adding Different Amounts of Plant Seed Protein and Plant Seed Fiber

Cooking creams were prepared as described above, but based on different plant seeds, and adding different amounts of plant seed protein and plant seed fiber. Subsequently, the stability of the cooking creams was compared after 24 hours incubation in the fridge. Then, the suitability of the products as cooking cream was assessed.

TABLE 2

| | | Suitability as cooking |
|---|---|---|
| | Stability | cream (visual inspection |
| | (visual | of stability upon heating |
| | inspection | to 150 degrees Celsius, |
| | after | ability to blend with |
| Product | 24 hours) | food liquids) |
| Walnut cooking cream with 25 | Not suitable | Not suitable |
| wt. % walnut oleosomes and <1 | | |
| wt. % walnut protein | | |
| Walnut cooking cream with 25 | Poor | Good |
| wt. % walnut oleosomes and 3 | | |
| wt. % walnut protein | | |
| Walnut cooking cream with 25 | Medium | Poor |
| wt. % walnut oleosomes and 5 | | |
| wt. % walnut protein | | |
| Walnut cooking cream with 25 | Medium | Medium |
| wt. % walnut oleosomes, | | |
| 5 wt. % walnut protein and 1.5 | | |
| wt. % walnut fiber | | |
| Macadamia cooking cream with | Not suitable | Not suitable |
| 25 wt. % macadamia oleosomes | | |
| and <1 wt. % macadamia | | |
| protein | | |
| Macadamia cooking cream with | Poor | Poor |
| 25 wt. % maize oleosomes and | | |
| 3 wt. % macadamia protein | | |
| Macadamia cooking cream with | Poor | Poor |
| 25 wt. % macadamia oleosomes | | |
| and 5 wt. % macadamia protein | | |
| Macadamia cooking cream with | Poor/ | Poor/ |
| 25 wt. % macadamia oleosomes, | Medium | Medium |
| 5 wt. % macadamia protein and | | |
| 1.5 wt. % macadamia fiber | | |
| Peanut cooking cream with | Not suitable | Not suitable |
| 25 wt. % peanut oleosomes and | | |
| <1 wt. % peanut protein | | |
| Peanut cooking cream with | Poor | Poor |
| 25 wt. % peanut oleosomes and | | |
| 3 wt. % peanut protein | | |
| Peanut cooking cream with | Poor | Poor |
| 25 wt. % peanut oleosomes and | | |
| 5 wt. % peanut protein | | |
| Peanut cooking cream with | Poor/ | Poor/ |
| 25 wt. % peanut oleosomes, | Medium | Medium |
| 5 wt. % peanut protein and | | |
| 1.5 wt. % peanut fiber | | |
| Cashew nut cooking cream with | Not suitable | Not suitable |
| 25 wt. % cashew nut oleosomes | | |
| and <1 wt. % cashew nut | | |
| protein | | |
| Cashew nut cooking cream with | Poor | Poor |
| 25 wt. % cashew nut oleosomes | | |
| and 3 wt. % cashew nut protein | | |
| Cashew nut cooking cream with | Poor | Poor |
| 25 wt. % cashew nut oleosomes | | |
| and 5 wt. % cashew nut protein | | |
| Cashew nut cooking cream with | Poor/ | Poor/ |
| 25 wt. % cashew nut | Medium | Medium |
| oleosomes, | | |
| 5 wt. % cashew nut protein and | | |
| 1.5 wt. % cashew nut fiber | | |
| Brazil nut cooking cream with | Not suitable | Not suitable |
| 25 wt. % Brazil nut oleosomes | | |
| and <1 wt. % Brazil nut protein | | |
| Brazil nut nut cooking cream | Poor | Poor |
| with | | |
| 25 wt. % Brazil nut oleosomes | | |
| and 3 wt. % Brazil nut protein | | |
| Brazil nut cooking cream with | Poor | Poor |
| 25 wt. % Brazil nut oleosomes | | |
| and 5 wt. % Brazil nut protein | | |
| Brazil nut cooking cream with | Poor/ | Poor/ |
| 25 wt. % Brazil nut oleosomes, | Medium | Medium |
| 5 wt. % Brazil nut protein and | | |
| 1.5 wt. % cashew nut fiber | | |
| Sunflower cooking cream with | Poor | Poor |
| 25 wt. % sunflower oleosomes | | |
| and <1 wt. % sunflower protein | | |
| Sunflower cooking cream with | Good | Good |
| 25 wt. % sunflower oleosomes | | |
| and 3 wt. % sunflower protein | | |
| Sunflower cooking cream with | Very good | Very good |
| 25 wt. % sunflower oleosomes | | |
| and 5 wt. % sunflower protein | | |
| Sunflower cooking cream with | Excellent | Excellent |
| 25 wt. % sunflower oleosomes, | | |
| 7.5 wt. % sunflower protein and | | |
| 1.2 wt. % sunflower fiber | | |

It was surprisingly found that a cream comprising sunflower oleosomes, at least ~2-3 wt. % sunflower seed protein and optionally sunflower seed fiber, provides for the best cream stability and suitability as cooking cream, in comparison to other seeds or lower protein/fiber content. The sunflower-based cooking cream has a surprisingly higher stability and ability to blend with food liquids also after in high heat applications, as compared to cooking creams based on other plant seeds. The appropriate (relative) amounts of sunflower oleosome and sunflower protein achieves excellent stability and cooking properties.

The result that the composition sunflower oleosome outperforms the composition comprising walnut oleosomes is surprising, because walnut is often associated with barista milks. Furthermore, sunflower oleosomes and sunflower proteins are approved novel foods (whereas walnut oleosomes are typically considered not to be).

Comparison with Prior Art Creams

### Materials

Commercially available 31% fat plant-based cream, sunflower oil (Albert Heijn), sunflower lecithin (Original Superfoods, Unlimited health) and sunflower protein (Sunbloom) were commercially purchased.

### Methods

### 1. Sample Preparation

Three cooking creams were prepared:
(1) Cooking Cream as described herein (sunflower-based cooking cream comprising 10-40 wt. % sunflower oleosomes and 0.5-15 wt. % sunflower protein, with respect to the total weight of the sunflower-based cooking cream);
(2) an artificial emulsion with 66.5% water, 25% sunflower oil, 7.5% sunflower protein and 1% lecithin; and
(3) unaltered Flora Plant 31% fat as commercial reference.

The artificial emulsion was prepared by stirring all ingredients together, followed by high-speed homogenization at 20000 rpm for 2 minutes and high-pressure homogenization at 180 bar for 5 passes.

### 2. Heating Stability

The heating stability of all samples was measured, by weighing 40 g of cooking cream, heating to 120° C. in a sauce pan up until the boiling point was reached, after which a stable temperature of 120° C. was kept. The heating stability was determined by the time from the start of the boiling point up until beginning of oil leakage and complete destruction of the cream.

### 3. Alcohol Stability

The alcohol stability of TTM cream and the artificial emulsion was measured by mixing 10 g of cooking cream with brandy (30% vol alcohol) to reach a total of 20% w/w alcohol in the total mixture. Then the physical stability of each cooking cream in 20% alcohol was measured by the physical stability over 48 hours. The inverse volume of separated serum at the top divided by the total volume, gives the value for physical stability, according to formula 1:

$$Physical stability ( \% ) = \frac{( total volume - serum top volume )}{total volume} \times 100 \% \qquad Formula 1$$

### 4. pH Stability

The pH stability of all samples was measured by the physical stability over 48 hours at pH 4, 5 and 7. The pH of the samples was adjusted to 4, 5 and 7 at t0 using 0.1-1 mmol hydrochloric acid. Then 6 mL of sample was transferred to a 15 mL tube and observed for phase separation over 48 hours. The physical stability is again calculated using Formula 1.

### 5. Consistency

The consistency of all samples was analyzed on a plastic hydrophobic surface over 140 mm height. A 0.2 mL cooking cream sample was dropped at the top of the surface. The inverse of the time that it took the sample to flow down over the 140 mm hydrophobic surface (“flow time”) was measured as an indication of cooking cream consistency, according to formula 2:

$$Consistency ( \% ) = \frac{1}{flow time} \times 100 \% \qquad Formula 2$$

### Results

1. Heating stability

| | 31% fat plant- | | |
|---|---|---|---|
| Timepoint | based cream | Artificial | TTM |
| Beginning of oil leakage | 50 s | 1 min 25 s | 1 min 50 s |
| Complete destruction | 4 min 45 s | 3 min 30 s | 5 min 35 s |

The time taken for the cooking cream according to the invention from the moment of boiling to the start of oil leakage was 220% and 130% higher than the Flora plant and artificial emulsion respectively. And the time taken for the cooking cream according to the invention from the moment of boiling to the start of oil leakage was 118% and 160% higher than the Flora plant and artificial emulsion respectively. From this can be concluded that the cooking cream according to the invention is more stable against heating than an artificial emulsion as well as a commercial reference.

2. Alcohol stability

Physical stability of cooking
cream in 20% alcohol (%)

| | Time 0 h | Time 48 h |
|---|---|---|
| TTM | 100 | 85 |
| emulsion | 100 | 60 |

The stability of cooking cream according to the invention is 1.4 times higher than an artificial emulsion in a 20% alcohol mixture.

3. pH stability

All cooking creams were stable at pH 4, 5 and 7 over 48 hours, no phase separation was observed

4. Viscosity

| | 31% fat plant- | | |
|---|---|---|---|
| | based cream | Artificial | TTM |
| Speed of flow (mm/s) | 31.1 | 23.3 | 17.5 |

The cooking cream according to the invention flows slowest over a hydrophobic plastic surface, indicating the thickest consistency. This can be very beneficial to the creaminess that a cooking cream provides to recipes and products.

1. A method for obtaining a sunflower-based cooking cream, the method comprising:
a) providing a slurry comprising water and comminuted sunflower seeds;
b) subjecting the slurry to liquid-solid separation to obtain a liquid composition comprising sunflower oleosomes; and
c) adjusting the protein content before and/or after step b) to obtain a sunflower-based cooking cream comprising 10-40 wt. % sunflower oleosomes and between 0.5-15 wt. % sunflower protein,
wherein the term oleosome refers to a membrane encapsulated oil droplet, wherein the oil droplet preferably comprises triacylglycerol and/or wherein the membrane preferably comprises phospholipid and protein preferably wherein the protein comprises oleosin, caleosin, and/or steroleosin.

2. The method according to claim 1, wherein adjusting the protein content involves combining the slurry of step a) with a composition comprising sunflower protein in an amount chosen to obtain a slurry comprising between 10-40 wt. % sunflower oleosomes and between 0.5-15 wt. % sunflower protein with respect to the weight of the slurry.

3. The method according to claim 1, wherein adjusting the protein content involves combining the liquid composition comprising sunflower oleosomes of step b) with a composition comprising sunflower protein in an amount chosen to obtain a sunflower-based cooking cream comprising between 10-40 wt. % sunflower oleosomes and between 0.5-15 wt. % sunflower protein with respect to the weight of the sunflower-based cooking cream.

4. The method according to claim 1, wherein the sunflower-based cooking cream comprises
between 60-78.5 wt. % water;
between 15-35 wt. % fat; and
between 1-10 wt. % protein
with respect to the total weight of the sunflower-based cooking cream.

5. The method according to claim 1,
wherein the sunflower-based cooking cream comprises 70-95 wt. % fat and 5-30 wt. % protein, calculated on the total weight of sunflower-based cooking cream; and/or
wherein the sunflower-based cooking cream is liquid.

6. (canceled)

7. The method according to claim 1,
wherein the slurry of step a) comprises between 1-30 wt. % comminuted sunflower seeds and between 70-99 wt. % water, with respect to the total weight of the slurry; and/or
wherein the liquid composition comprising sunflower oleosomes of step b) comprises:
between 50-70 wt. % water;
between 20-40 wt. % fat; and
between 1-7.5 wt. % protein,
with respect to the total weight of the liquid composition.

8. (canceled)

9. The method according to claim 2,
wherein the composition comprising sunflower protein comprises:
between 40-95 wt. % sunflower protein; and
between 0.5-10 wt. % sunflower fat,
with respect to the total weight of the composition comprising sunflower protein, and/or
wherein the composition comprising sunflower protein is obtained from the solid phase of the liquid-solid separation in step b).

10. (canceled)

11. The method according to claim 2, wherein the composition comprising sunflower protein is a protein concentrate or protein isolate obtained from the solid phase of the liquid-solid separation in step b).

12. The method according to claim 1, wherein the slurry comprising water and comminuted sunflower seeds is obtainable by
i) immersing sunflower seeds, preferably dehulled sunflower seeds, in aqueous medium; and
ii) comminuting the immersed sunflower seeds by blending, mixing, milling and/or compressing.

13. The method according to claim 1 claims,
wherein the liquid-solid separation is performed by filtration, centrifugation, and/or by using a decanter; and/or
wherein the obtained sunflower-based cooking cream in step c) is pasteurized and/or subjected to Ultra-High-Temperature (UHT) treatment.

14. (canceled)

15. The method according to claim 1, wherein the method does not involve high-pressure homogenization.

16. A sunflower-based cooking cream obtainable by the method according to claim 1.

17. A sunflower-based cooking cream comprising 10-40 wt. % sunflower oleosomes and 0.5-15 wt. % sunflower protein, with respect to the total weight of the sunflower-based cooking cream,
wherein the term oleosome refers to a membrane encapsulated oil droplet, wherein the oil droplet preferably comprises triacylglycerol and/or wherein the membrane preferably comprises phospholipid and protein preferably wherein the protein comprises oleosin, caleosin, and/or steroleosin.

18. The sunflower-based cooking cream according to claim 17, wherein the sunflower-based cooking cream comprises:
between 60-78.5 wt. % water;
between 15-35 wt. % fat; and
between 1-10 wt. % protein,
with respect to the total weight of the sunflower-based cooking cream.

19. The sunflower-based cooking cream according to claim 17,
wherein the sunflower-based cooking cream is liquid; and/or
wherein the sunflower-based cooking cream is hypoallergenic; and/or
wherein the sunflower oleosomes and sunflower protein are hypoallergenic; and/or
wherein the sunflower-based cooking cream is a clean label cooking cream.

20. (canceled)

21. The sunflower-based cooking cream according to claim 17, further comprising:
no hydrocolloids, or not more than 1 wt. % hydrocolloids; and/or
only sunflower-based ingredients, or no more than 2 wt. % non-sunflower ingredients, all with respect to the total weight of the sunflower-based cooking cream in dry form.

22. The sunflower-based cooking cream according to claim 17, which has a stability as determined by a phase separation rate of less than 2.5×10-5 mL/s, preferably less than 2×10-5 mL/s.

23. A method for cooking food comprising:
utilizing the sunflower-based cooking cream according to claim 17.

24. A method for increasing stability of cooking cream, comprising adding sunflower-based oleosomes and/or sunflower protein for increasing stability of a cooking cream.
